(19) United States
(12) Patent Application Publication
(10) Pub. No.: US 2008/0147437 A1
(43) Pub. Date: Jun. 19, 2008

(54) Intelligent Guided Registration Within A Health Information System

(76) Inventors: Gregory P. Doud, Loveland, OH (US); Charles Thomas Pickrell, Oregonia, OR (US)

Correspondence Address: HASSE & NESBITT LLC, 8837 CHAPEL SQUARE DRIVE, SUITE C, CINCINNATI, OH, 45249, US

(21) Appl. No.: 11/612,574

(22) Filed: Dec. 19, 2006

(51) Int. Cl. G06Q 40/00; G06F 3/048; G06F 3/00

(52) U.S. Cl. 705/2; 715/811; 715/762

(57) ABSTRACT

A method of intelligently guiding a registrar through a patient registration within a health information system. The method utilizes an inverted tree-type decision structure in which a question path is dependent on and determined by the responses to prior questions. A registrar is guided through the decision structure by responding to a series of questions. Within the decision structure, one or more actions are performed, which may include the return of an identifier to an initiating field in the health information system. An administrator may customize the questions, responses, and screen presentations of the decision structure through a Windows®-based graphical user interface. When multiple identifiers are returned in a registration session, the identifiers are automatically sequenced according to a predetermined hierarchy.

### FIELD OF THE INVENTION

The present invention relates generally to a health care patient registration system and, more particularly, to a method for guiding a user through a questionnaire during a patient registration to automatically trigger one or more actions related to the registration. The triggered actions can include retrieval of an insurance plan identifier. When multiple insurance plan identifiers are retrieved, the identifiers are automatically sequenced according to a predetermined hierarchy. The questionnaire may be customized for a particular health care facility, and easily modified to adapt to changes in health insurance plans.

### BACKGROUND OF THE INVENTION

When a patient enters a health care facility to receive services, the patient's initial interaction is with a registrar who enters data about the patient into the healthcare facility's patient registration system. Typically, the registrar requests personal and medical history information from the patient. During the registration process, the registrar will also ask the patient for information about the patient's health insurance coverage. Typically, the patient will provide the registrar with one or more insurance cards for each of the patient's insurance providers. Some patients have no health insurance coverage at all, while others may be covered by multiple insurance plans. An example of multiple insurance coverage is an elderly person who has both Medicare insurance and a Medicare supplement. During patient registration, a different code or identifier is entered for each of the patient's different health insurance plans. These identifiers are assigned by the healthcare facility, and usually comprise a descriptive phrase or combination of alphanumeric characters. Due to the large number of insurance plans and insurance companies (both commercial and governmental), the list of available codes at a facility typically numbers in the hundreds or even thousands.

During a patient registration, the registrar must select the correct identifier for the patient's insurance provider. A healthcare facility's registration system usually provides only a simple list of all the insurance plan identifiers for the facility. Sometimes a brief description is also provided for each identifier. The patient's insurance card does not provide any guidance about the insurance plan identifier. Consequently, a registrar must learn and remember the facility's particular identifiers for each of the different health insurance plans, and manually enter these identifiers during the registration process. If the registrar enters a wrong insurance plan, the health insurance company will deny a claim for the service, and return the claim to the healthcare facility for correction. Denied claims result in costly rework and delayed payment. Accordingly, it is very important that the patient's insurance information be entered correctly at the time of registration.

When a patient has more than one health insurance provider, the registrar must enter multiple plan identifiers, one for each provider, into the registration system. The multiple identifiers must be entered into the system in the correct sequence in order for the facility to receive payment. The government and health insurance industry have determined a sequence in which multiple insurance providers will pay claims. Claims that are submitted in the wrong sequence are denied payment. For example, a healthcare facility that treats a patient with Medicare and a Medicare supplement must submit a claim for payment to Medicare first before submitting a claim to the Medicare supplement provider. If the healthcare facility were to submit the claim to the Medicare supplement provider first, both Medicare and the Medicare supplement provider would deny the claim. Health care facilities have relied on classroom education, emails, memos, spreadsheets and “sticky notes” to assist registrars with obtaining the correct insurance plan identifiers and entry sequence. However, even with the best training, errors have occurred due to the large number of insurance plans encountered by the registrars.

To complicate the registration process even further, insurance companies frequently issue changes to their insurance plans. These changes may consist of different identifiers for the same named plans, or substituting one plan's identifying information for another plan's. Each time one of these changes is received, the healthcare facility must notify each of the registrars, who then must make a note of the change, or try to remember to implement the change the next time the registrar encounters that insurance plan.

In addition to health insurance, a registrar may enter other codes or identifiers during the registration process related to, for example, scheduling the patient for a particular medical procedure, or identifying the patient's referring physician. The number of available identifiers in these other areas can also be voluminous, requiring extra time on the part of the registrar to select the correct identifier for the particular circumstance. Likewise, entry of an incorrect identifier or code in these additional fields is costly and time-consuming. Accordingly, it is desirable to have a system and method for guiding a registrar in the selection of a particular identifier from a list of available identifiers during a patient registration session. The system and method should be accurate and easy for the registrar to use. Further, it is desirable to have a method for automatically sequencing multiple identifiers based upon a predefined sequencing hierarchy. Even further, it is desirable that the system be easily updatable by a person having limited computer programming skills, so that changes with respect to the particular identifiers at a facility can be easily and quickly entered into the registration system.

### SUMMARY OF THE INVENTION

The present invention provides for the intelligent guidance of a registrar during a patient registration session by stepping the registrar through a questionnaire in order to automatically trigger one or more actions related to the registration.

In one embodiment, the present invention provides a method for guiding a registrar during a patient registration in a health information system. The method includes detecting a designated field within the health information system, accessing a questionnaire upon detection of the designated field, and displaying the questionnaire on a graphical user interface. The questionnaire includes a first question and one or more responses for the first question. After a response to the first question is received through an input device, the received response is analyzed in a computer process to determine whether the response indicates an action to be performed or one or more additional questions in the questionnaire. When the received response indicates at least one additional question in the questionnaire, additional questions in the questionnaire are displayed, responses received, and any indicated actions performed, until a received response indicates an end processing action. The end processing action is then performed in conjunction with the patient registration. The questionnaire is displayed for the registrar in a graphical format, and can be graphically modified by a system administrator at an individual health care facility without the use of computer programming code.

In another embodiment, the present invention provides a method of facilitating selection of a health insurance plan during a patient registration in a health information system. The method includes the steps of detecting an insurance plan identification field within the health information system, accessing a health insurance questionnaire upon detection of the insurance plan identification field, and displaying the health insurance questionnaire on a graphical user interface. The health insurance questionnaire includes at least one question having one or more responses. After a response to the questionnaire is received through an input device, the response is analyzed in a computer process to determine whether the received response branches to one or more additional questions in the questionnaire or an action to be performed. When the received response branches to at least one additional question in the questionnaire, additional questions in the questionnaire are iteratively displayed and responses received and analyzed until a received response branches to an end processing action. The end processing action is then performed in conjunction with the patient registration.

In yet another embodiment, the present invention provides a system for facilitating the performance of an action in conjunction with a patient registration at a health care facility. The system includes a monitor for detecting a designated field in a health care information system, and a first computer process for retrieving a questionnaire in response to detection of the designated field. The questionnaire includes one or more questions, responses, and actions related together in a decision structure. The system also includes a graphical user interface for displaying the questionnaire, and one or more input devices for receiving user responses to the questionnaire. A second computer process is included for analyzing user responses to the questionnaire, and reiteratively displaying questions from the questionnaire and receiving user responses until a user response indicates an end processing action to be performed. The end processing action may include insertion of a health insurance plan identifier into an insurance plan identification field of the health information system.

### BRIEF DESCRIPTION OF THE DRAWINGS

FIG. 1 is a schematic view of a healthcare patient registration system;

FIG. 2 is a block diagram depicting a registrar workstation in greater detail;

FIG. 3 is a block diagram illustrating the primary components of the intelligent guided registration system;

FIG. 4 depicts a representative inverted decision tree structure for a questionnaire;

FIG. 5 is a representative screen display for a health information system;

FIG. 6 is an exemplary screen display of an initial question and response choices from a questionnaire;

FIG. 7 is an exemplary screen display depicting a user selecting a response choice;

FIG. 8 is an exemplary screen display showing a second question and set of response choices from a questionnaire;

FIG. 9 is an exemplary screen display similar to FIG. 5, showing entry of an identifier in a first health insurance plan field;

FIG. 10 is an exemplary screen display of an initial question and response choices from a questionnaire;

FIG. 11 is an exemplary screen display showing a second question and set of response choices from a questionnaire;

FIG. 12 is an exemplary screen display similar to FIG. 5, showing entry of two identifiers in the first two health insurance plan fields;

FIG. 13 is an exemplary screen display of a COB rule question;

FIG. 14 is an exemplary screen display similar to FIG. 12, showing the resequenced order of the identifiers in the first two health insurance plan fields;

FIG. 15 is an exemplary screen display showing a question tree file in an administrative mode;

FIG. 16 is an exemplary screen display similar to FIG. 15, showing an administrator selecting a node;

FIG. 17 is an exemplary screen display showing an action item associated with the node selected in FIG. 16;

FIG. 18 is an exemplary screen display showing the File Menu option selections, and the selection of the Open option to open a node;

FIG. 19a is an exemplary screen display showing the Edit menu option selections, and the selection of the Find option;

FIG. 19b is an exemplary screen display showing entry of a character string for the Find menu option;

FIG. 20 is an exemplary screen display showing a node and action items associated with the node;

FIG. 21a is an exemplary screen display showing the Action menu option, and the selection of the Show Question Templates option;

FIG. 21b is an exemplary screen display of a question template;

FIG. 22 is an exemplary screen display of an edit question function within the administrative mode; and

FIG. 23 is an exemplary screen display of an edit action function within the administrative mode.

### DETAILED DESCRIPTION OF THE INVENTION

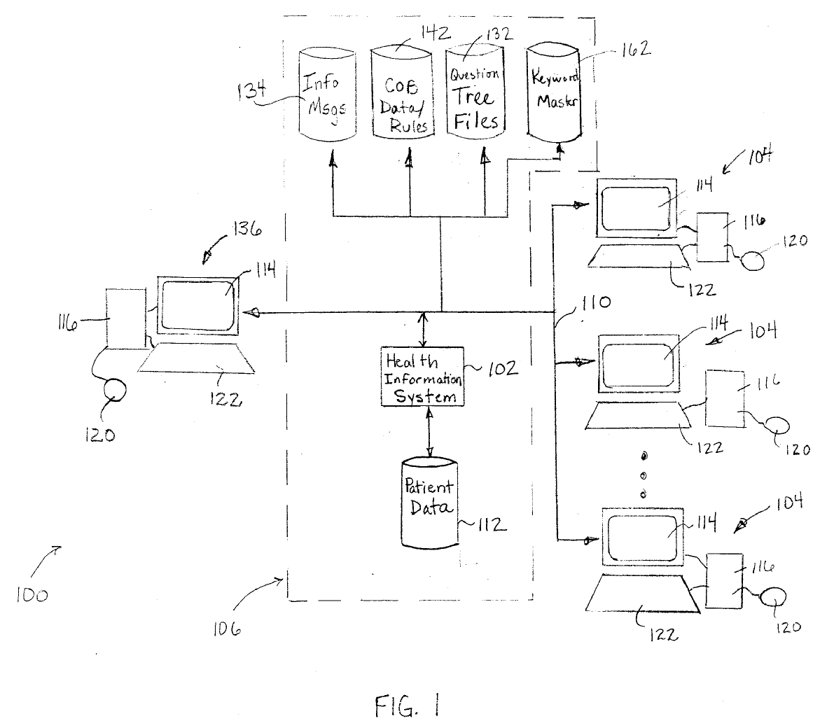

Referring now to the drawing figures, in which like numerals indicate like elements throughout the views, FIG. 1 discloses a health care patient registration system 100 with intelligent guided registration. As shown in FIG. 1, patient registration system 100 includes a health information system 102 located on a server 106, and a plurality of user workstations 104. Workstations 104 and server 106 are connected through a dedicated communications network 110. Each of the individual workstations 104 may run an application of health information system 102 to register patients. The workstation application programs interface with the health information system 102 on server 106 to send and receive patient data. A registrar at a workstation 104 may also use an emulator program or web browser to interface with health information system 102 on server 106. Server 106 controls data transfer between the application programs and a patient database 112. Patient database 112 contains patient records for each patient registered within the health information system.

Each of the individual workstations 104 includes a computer processor (CPU) 116 having a memory associated therewith, and a graphical user interface such as, for example, a computer monitor 114, for displaying information to the user. Input devices such as a mouse 120 and keyboard 122 are connected to processor 116 for inputting information from the user. In addition to mouse 120 and keyboard 122, other input devices can be associated with workstations 104 for inputting data and user responses. These devices can include, among others, a touchscreen, application program or a digital storage disk. In the exemplary embodiment described herein, workstations 104 are operated under a Microsoft Windows® operating system, which is manufactured by the Microsoft® Corporation of Redmond, Wash. Other systems and embodiments may use other hardware and software components to accomplish the functionality of the invention, however, without departing from the scope of the invention.

In addition to the health information system application, each workstation 104 executes an intelligent guided registration (IGR) application program for performing actions specific to the patient registration. The workstation IGR programs interface with server 106 over communication link 110 to access common data files. The IGR program interfaces with server 106 to access questionnaire files from a digital storage medium 132. Informational messages associated with the questionnaire files are stored in a second digital storage medium 134. An additional digital storage medium 142 stores rules for sequencing identifying character strings, while yet another storage medium 162 stores a file of identifier updates. The IGR application programs may also interface with server 106 to store activity logs for each of the individual workstations.

One or more administrator workstations 136 interface with the digital storage mediums on server 106 through communication link 110. Administrator workstations 136 include a processor 116, graphical user interface 114, and one or more input devices 120, 122 that are similar to and interconnected in the same manner as registrar workstations 104. Administrator workstations 136 may be used to modify the IGR system files, as will be described in more detail below. Any number of workstations 104 may run the IGR application program in conjunction with server 106 simultaneously within patient registration system 100.

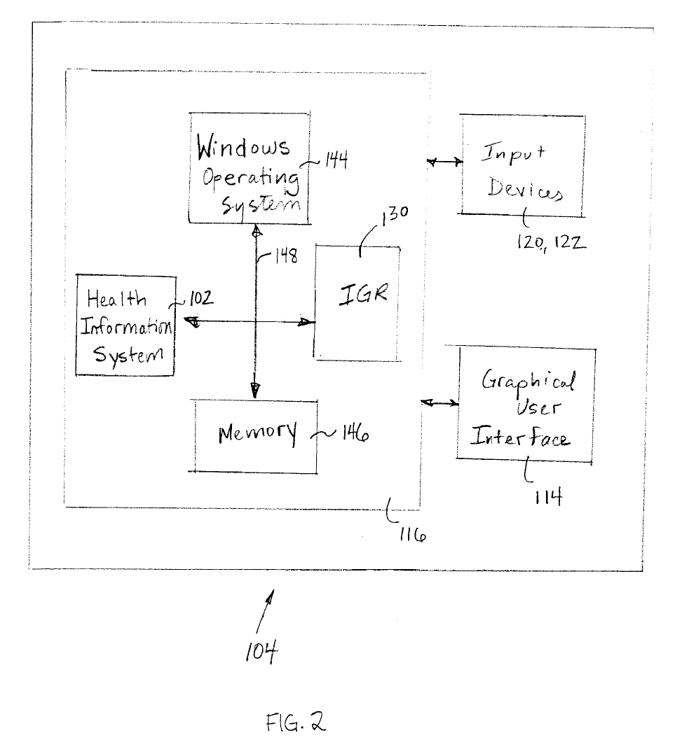

FIG. 2 is a block diagram showing a workstation 104 in greater detail. As shown in FIG. 2, processor 116 executes application programs for both health information system 102 and intelligent guided registration system 130. These programs run under the control of a Windows® operating system 144. A memory 146 within processor 116 stores the application programs, as well as provides for the temporary storage of operational data required by the application programs. Health information system 102, intelligent guided registration system 130, operating system 144 and memory 146 all interface within workstation 104 as indicated by connecting lines 148.

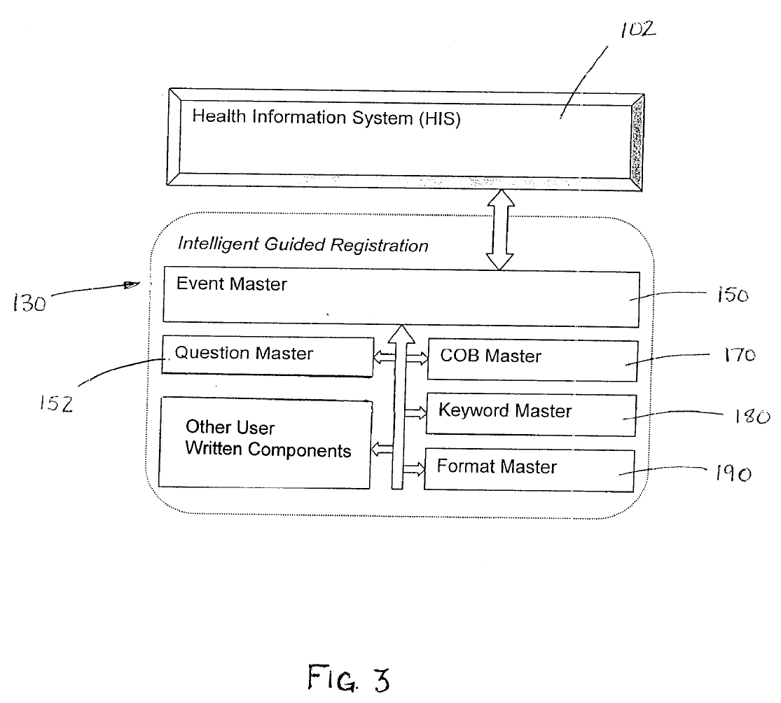

FIG. 3 is a block diagram of the primary components of the intelligent guided registration (IGR) system 130. As shown in FIG. 3, an Event Master component 150 controls the interface between the IGR program 130 and health information system 102. Event Master 150 monitors the operation of health information system 102, as well as individual users' keystrokes on keyboards 122, to detect when to initiate operation of the IGR system. Event Master 150 triggers the IGR system when execution of the health information system reaches a designated data field. When Event Master 150 detects the designated data field, the Event Master component invokes a Question Master component 152. In the exemplary embodiment described herein, the designated data field is an insurance plan identification field. However, the Event Master component may be used to detect other types of data fields, and trigger a guided questionnaire session with respect to the other types of fields, without departing from the scope of the invention.

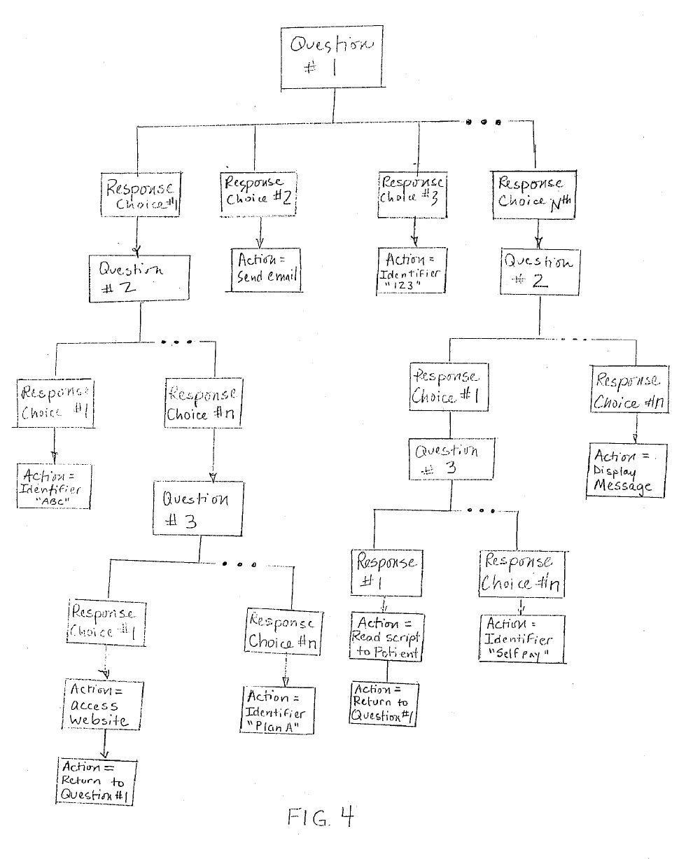

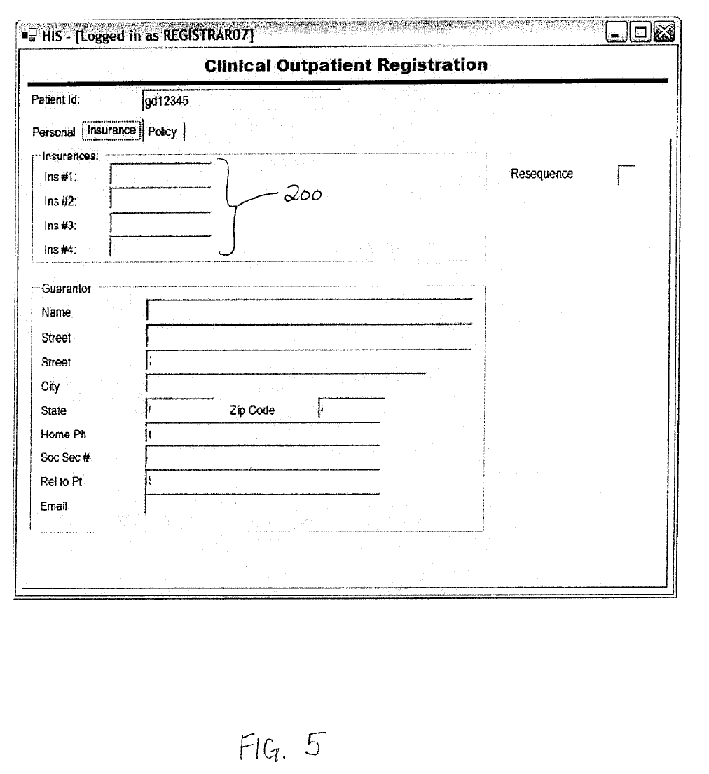

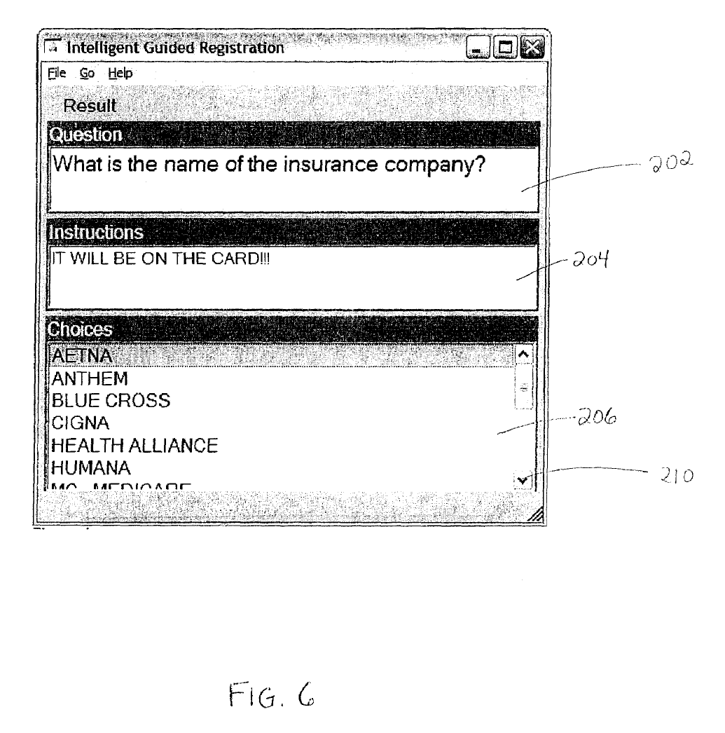

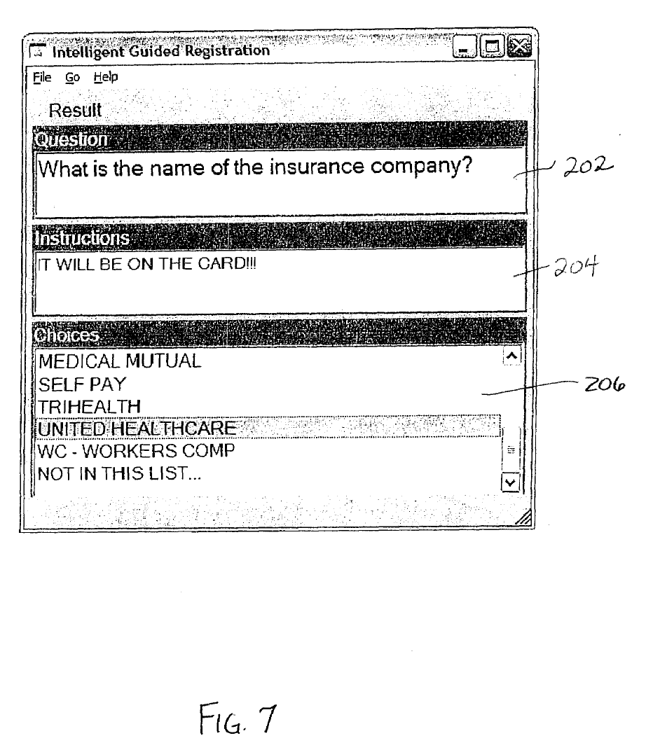

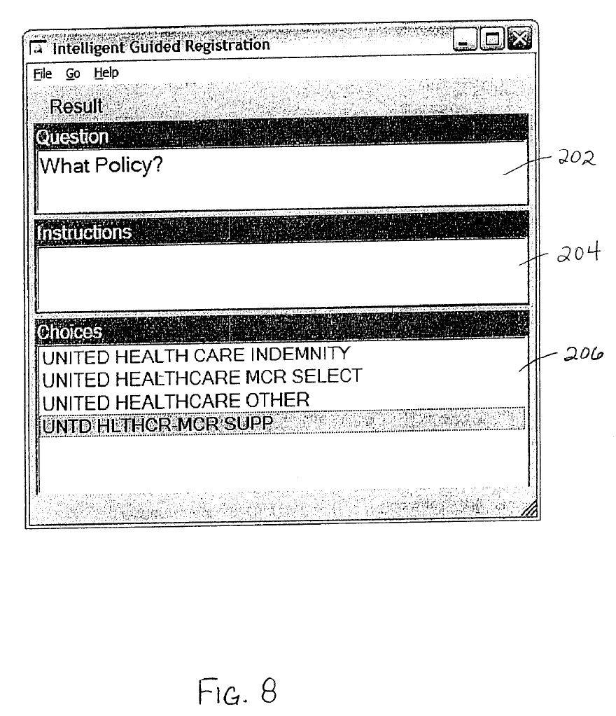

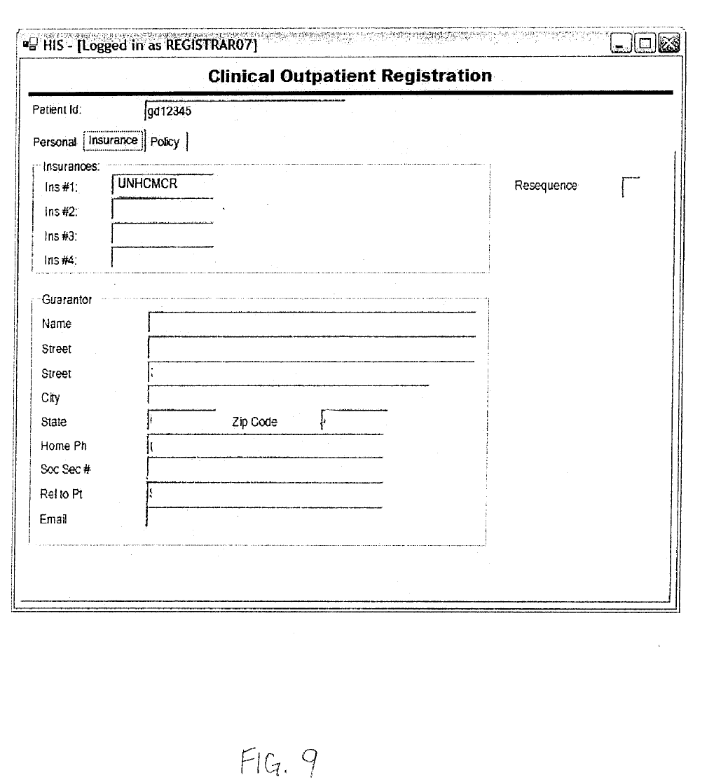

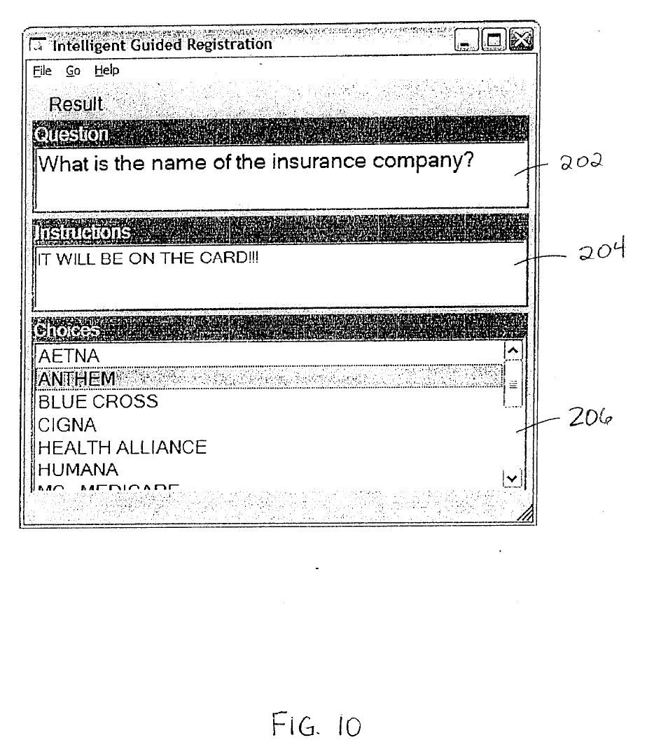

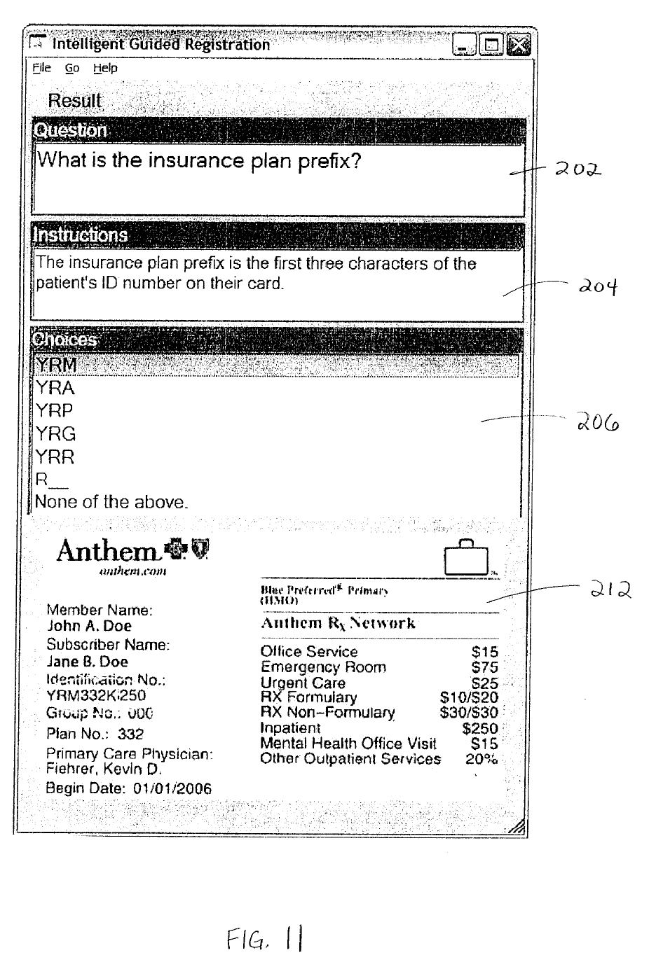

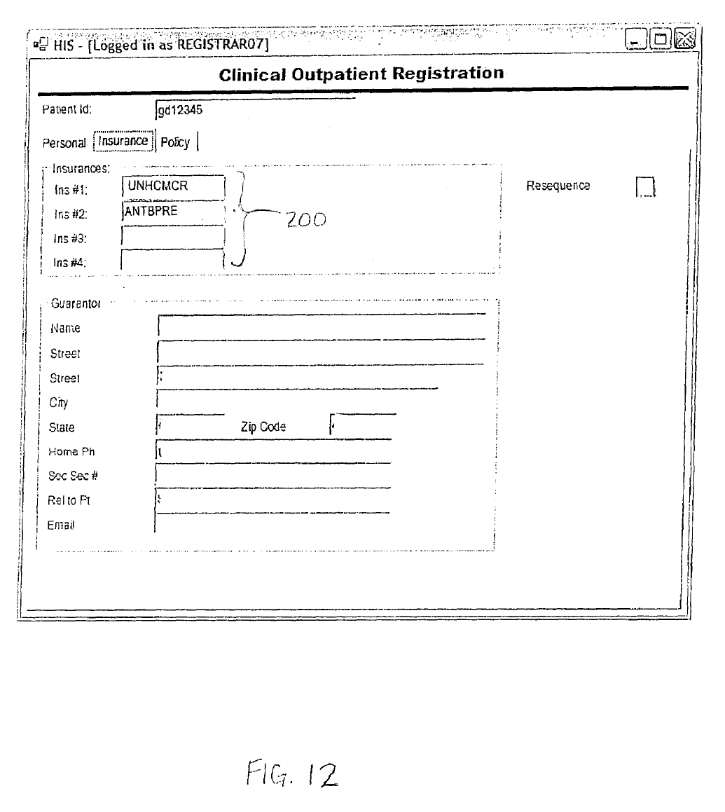

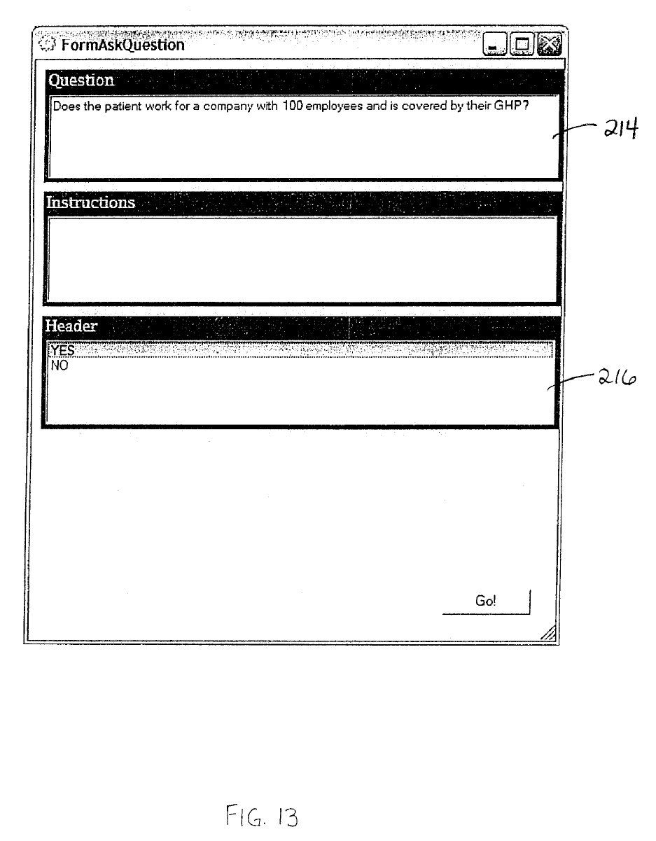

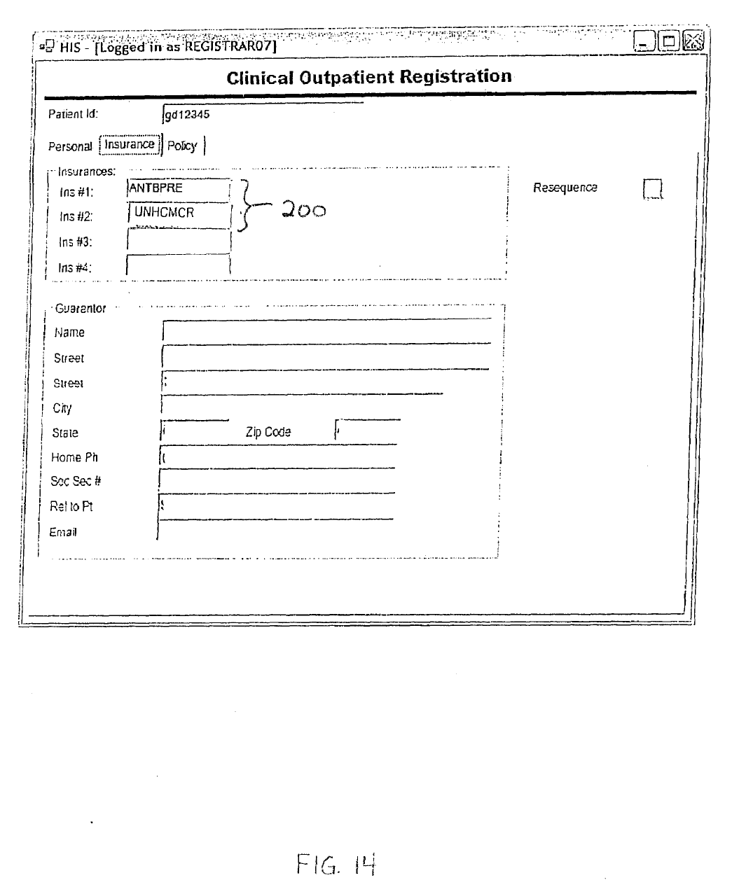

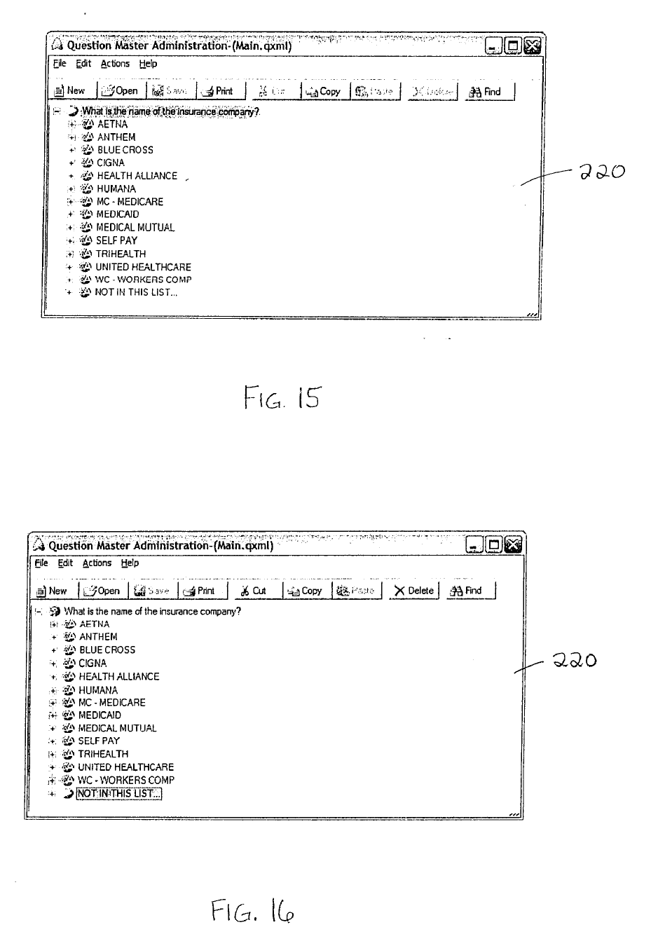

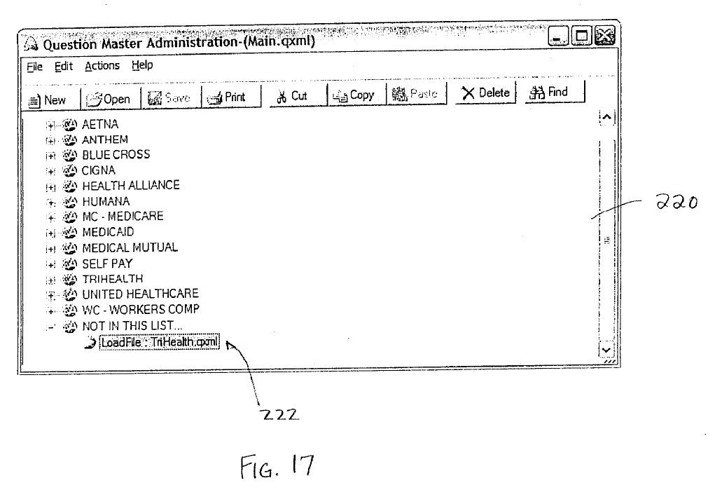

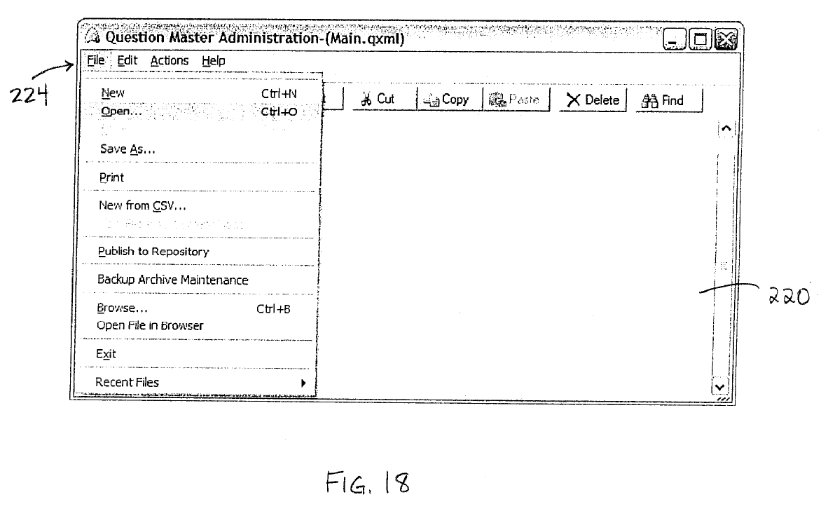

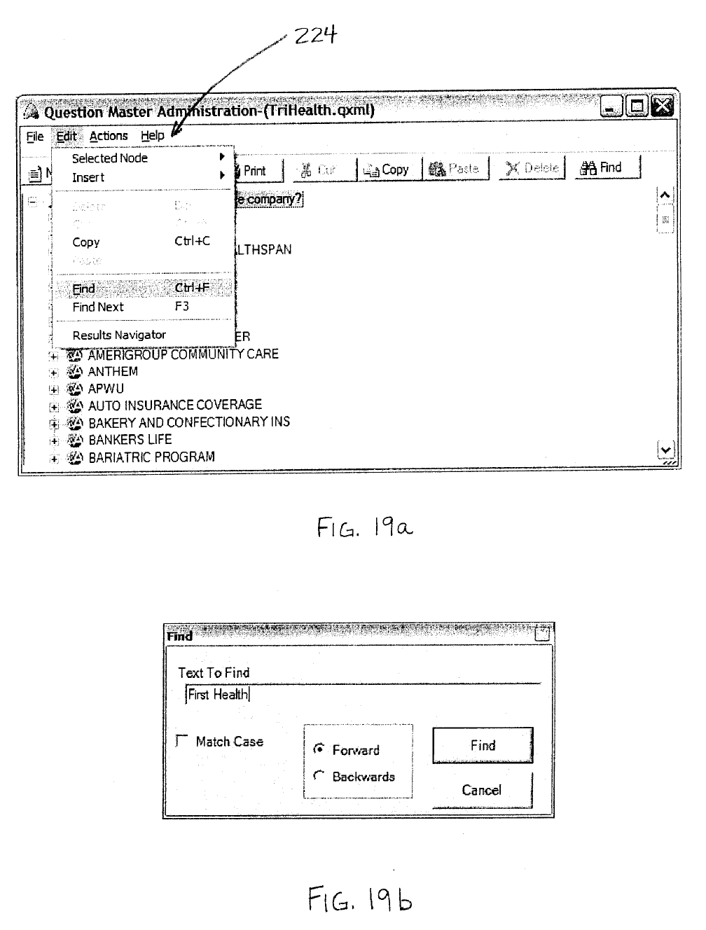

The Question Master component 152 guides the user through a questionnaire in an interactive question and answer session to determine one or more specific actions to be performed for the patient registration. Once invoked, Question Master 152 accesses a questionnaire file and displays a portion of the file on a workstation graphical user interface. The questionnaire file may be accessed from digital storage medium 132 on server 106. Alternatively, if the desired questionnaire is already resident in workstation processor memory 146, Question Master 152 may access the questionnaire directly from the workstation memory. If the questionnaire file in workstation memory 146 is an older version than the questionnaire file on digital storage medium 132, Question Master 152 reloads the questionnaire file from the digital storage medium into the workstation memory. The questionnaire is a data file structured as a decision tree having one or more question branches, as shown in FIG. 4. Each of the questions in the decision tree has one or more listed responses, which each branch to an additional question or an action to be performed. As indicated by the connecting lines in FIG. 4, the particular path of questions presented to a user is dependent upon the responses to the previous questions.

When invoked, Question Master 152 displays an initial question from a questionnaire and a number of response choices for the question on a workstation graphical user interface. Question Master 152 then enters a holding pattern awaiting a response through one of the workstation input devices. When a response is received, Question Master 152 analyzes the inputted response to determine the path of the decision structure corresponding to the response. The selected path will lead to a second question within the questionnaire, link to a second questionnaire, or specify an action. Question Master 152 may also return processing to a previous question or questionnaire. Accordingly, if a question tree “A” links to a question tree “B”, an action in question tree “B” could restart processing at the beginning of question tree “A”.

When the question path leads to a second question, the second question is displayed on the workstation graphical user interface along with the one or more response choices corresponding to that question. Question Master 152 then again enters a holding pattern awaiting a response to the second question. When a response is received, the response is analyzed to determine the appropriate question path to follow based upon the response. The selected question path leads to an additional question and set of responses, or to an action. Question Master 152 continues this interactive navigation through the questionnaire decision tree, using the responses to select the appropriate path and performing any indicated actions, until reaching a terminating point. In an exemplary embodiment described in more detail below, the questionnaire corresponds to the health insurance plans offered at a healthcare facility. In this embodiment, Question Master 152 proceeds through the question paths in the questionnaire based upon the insurance information obtained from the patient, or the patient's insurance card, and input by the registrar. A health insurance questionnaire, however, is only an example of the types of questionnaires that could comprise the IGR system. Numerous other questionnaires could also be presented through the IGR system to guide a registrar to a particular action during a patient registration, depending upon the particular needs of a health care facility.

A number of different types of actions may be taken at various points in the questionnaire. One of the available actions is to return an identifier. An identifier may be an alphanumeric character string, a descriptive phrase, or another type of symbol or code indicative of a particular provider or service. A return identifier action typically occurs at the terminating point of a decision path in a questionnaire file. When a return identifier action is encountered, Question Master 152 passes a specific identifier from the questionnaire file to Event Master 150. Event Master 150 inserts the identifier into the health information system program in the designated field at which the event definition occurred. After the identifier is inserted in the designated field, IGR program processing terminates and control is returned to the health information system. A return identifier action is an end processing action within an interactive questionnaire session. Other actions may also be designated within the IGR system as end processing actions for a questionnaire session. An example of these other actions is a return to health information system command. In the exemplary health insurance embodiment, an identifier pertains to a particular insurance plan that is identified through the user's response(s) to the questionnaire. In the exemplary embodiment, Event Master 150 enters the returned identifier into an insurance plan identification field in the health information system.

Another type of action that may be taken within the questionnaire is to display an informational message. These informational messages are displayed in a separate window from the questions and responses, and provide assistance or direction to the user to take a particular action such as, for example, reading a scripted text to a patient. The message may provide advice to the patient or request that the patient provide additional information. Question Master 152 accesses the informational messages from digital storage medium 134 on server 106. The messages may be displayed in conjunction with a question to assist the user in obtaining the information necessary to respond to the question.

A third type of action that may be taken in the questionnaire is to access a website. In this action, the IGR system would automatically link to a website. The website would be displayed on the workstation graphical user interface so that the registrar could interact with the website to obtain information. This action may be taken to obtain additional information for the patient registration or to accomplish a particular task, such as, for example, approval from the patient's insurance provider. Following display of an informational message or linking to a website, the questionnaire may continue with additional questions or actions. In additional to the actions described above, any number of additional types of actions may be taken within the questionnaire, depending upon the particular needs of the healthcare facility.

Returning now to FIG. 3, IGR system 130 also includes a COB Master component 170. COB Master component 170 sequences the order of multiple identifiers based upon a predetermined hierarchy. COB Master 170 is invoked by Event Master 150 when more than one identifier is returned to the health information system from a questionnaire. Event Master 150 detects the entry of multiple identifiers in the designated fields of the health information system and passes the identifiers from the fields to COB Master 170. COB Master 170 sequences the identifiers based upon a predetermined value assigned to each identifier. After sequencing, the identifiers are returned to Event Master 150. Event Master 150 reinserts the identifiers into the designated fields of the health information system in the new sequenced order. To assist in determining the proper sequence for the identifiers, COB Master 170 may access one or more questions from COB Master database 142 on server 106. COB Master 170 displays each question from the COB Master database on the workstation graphical user interface during the registration session to enable the registrar to obtain the required sequencing information directly from the patient. The registrar's responses to the COB Rule questions are input to COB Master 170. COB Master 170 then applies the rules to the identifiers in a computer process to properly sequence the identifiers.

In the exemplary health insurance embodiment described herein, Event Master 150 invokes COB Master 170 after a registrar completes a questionnaire and indicates that there are no more health insurance identifiers to be entered into the health information system for the patient. This indication can be made by the registrar selecting a designated field in the IGR system, or by the registrar moving on to subsequent fields or screens in the health information system COB Master 170 is invoked to sequence the identifiers according to a claim payment hierarchy. This hierarchy is the order in which each claim should be sent to each of the patient's insurance providers for payment. Event Master 150 passes the inserted insurance plan identifiers to COB Master 170. Prior to the registration session, each of the identifiers is assigned to a category depending upon the type of insurance plan. Medicare, for example, would be assigned to one category, Medicare Supplements would be assigned to another category, and group health insurance plans would be assigned to yet another category. Each of the different categories is assigned a weight value based upon the category's payment priority. For example, identifiers associated with insurance plans that usually pay first are assigned a lower weight than identifiers associated with plans that are the last to receive a claim. The assigned categories are maintained within a file in COB Master database 142.

When COB Master 170 is invoked, the insurance plan identifiers are sorted based upon the values assigned to the particular insurance plan categories. The registrar's response(s) to the COB Master questions may vary the weight assigned to a particular insurance plan. In the exemplary health insurance embodiment, COB Master 170 sequences the insurance plan identifiers according to the order in which the claims should be submitted to each of the health insurance providers for payment. Accordingly, regardless of the order in which a patient's multiple health insurance coverages are entered into health information system 102, IGR system 130 will sequence the insurance plan identifiers into the proper payment order. Following the sequencing process, COB Master 170 passes the identifiers back to Event Master 150. Event Master 150 reinserts the identifiers into the designated insurance plan identification fields in the health information system in the proper payment order.

As shown in FIG. 3, IGR system 130 may also include a Keyword Master 180 for automatically determining when an insurance plan identifier in the health information system is outdated and should be replaced with a new identifier. Event Master 150 monitors execution of health information system 102 and detects when a preexisting patient record is accessed from patient database 112 during a patient registration. Event Master 150 invokes Keyword Master 180 when an identifier is preloaded into the designated field of the health information system during a registration. Event Master 150 retrieves the preloaded identifier from the designated field and passes the identifier to Keyword Master 180. Keyword Master 180 compares the passed identifier to a list of outdated identifiers due to be replaced in the system. A keyword file containing a list of outdated identifiers is accessed by Keyword Master 180 from Keyword Master database 162 on server 106. The keyword file contains a listing of the outdated identifiers and corresponding replacement identifiers. When Keyword Master 180 analyzes the identifier passed from Event Master 150, if an outdated identifier is detected, Keyword Master 180 passes the replacement identifier back to Event Master 150 for insertion into the designated field in the health information system. In this manner, Event Master 150 and Keyword Master 180 prevent outdated identifiers from being reentered into the health information system. In addition to the insurance plan identifiers of the exemplary embodiment, Keyword Master 180 may be utilized to perform similar character string substitutions in other fields within the health information system.

As shown in FIG. 3, IGR system 130 may also include a Format Master component 190. Format Master component 190 can be triggered by Event Master 150 during a registration session to verify data entries in one or more fields of the health information system. Format Master 190 can verify any fields in the health information system, not only the designated fields which trigger intelligent guided registration system 130. Format Master 190 can check that data entered into the health information system fields corresponds to the proper alphanumeric format expected in the fields. Additional functions performed by Format Master 190 can include verifying that the correct number of characters have been entered into a field, and checking that the data is a number, date, all letters, or any other type of format anticipated for a field. Other types of functions may also be performed by Format Master component 190 depending upon the particular needs established by the system administrator.

Intelligent guided registration system 130 will now be described with respect to an insurance plan identification application. This application is exemplary, however, and it is anticipated that the IGR system will also be applicable to other aspects of a patient registration process. FIG. 5 shows an exemplary screen display for entering health insurance data into a health information system. A health information system typically comprises a plurality of fields for recording a patient's health insurance data. In the system shown in FIG. 5, four fields are designated for entry of insurance plan identifying information. The information entered into these fields can comprise any type of identifying data such as, for example, a number, alphanumeric code, or descriptive phrase. Typically, the identifying information for these fields would be entered manually by a registrar. With the IGR system, when a registrar using a health information system reaches an insurance plan identification field, such as fields 200 shown in FIG. 5, the IGR system detects the fields and initiates an interactive questionnaire to guide the user to the appropriate entries for the fields.

FIG. 6 shows a representative screen displayed after Event Master 150 detects one of the designated insurance plan fields 200 of FIG. 5, and triggers Question Master 152. As shown in FIG. 6, the initial screen displayed by Question Master 152 includes a first window 202 that displays the first question of the questionnaire. In the exemplary embodiment shown, window 202 displays the initial question: “What is the name of the insurance company”? Beneath window 202 on the display screen, is a second window 204 that may contain informational messages for the registrar. In this example, window 204 contains the message “IT WILL BE ON THE CARD” to direct the registrar to the appropriate place to locate the insurance company name. Beneath window 204 is a third window 206, that contains one or more response choices for the question displayed in first window 202. The user may select any of the responses shown in third window 206 by pointing and clicking the mouse on the selected response. To reach a desired response when the list of responses is longer than the response window 206, the user may scroll down within the window by clicking on down arrow 210 along the right hand sign of the screen. Alternatively, the user may enter the first letter of the desired response to jump to the valid responses beginning with that letter. In the example shown, the user scrolls down to the “United Healthcare” choice, as shown in FIG. 7, and selects this response by pointing and clicking the mouse or pressing the enter key on the keyboard.

After a response is entered, Question Master 152 analyzes the response to determine the appropriate path to follow within the questionnaire. In this embodiment, the response “United Healthcare” branches to a second question “What Policy,” which is subsequently displayed in first window 202, as shown in FIG. 8. A plurality of responses to the second question are displayed in window 206. The registrar selects one of the responses by double clicking on the choice or highlighting and pressing return. In this example, the registrar selects “UNTD HLTHCR-MCR SUPP”. Question Master 152 evaluates the registrar's response to determine where to navigate to within the decision tree structure of the questionnaire. In this example, the response “UNTD HLTHCR-MCR SUPP” leads to a terminus point containing an insert identifier action. Question Master 152 passes the identifier for the United Healthcare Medicare Supplement insurance plan to Event Master 150, which then inserts the insurance plan identifier into the first insurance plan identification field 200 of the health information system, as shown in FIG. 9.

If a patient has more than one health insurance provider, the registrar may tab into a second insurance plan identification field 200 in the health information system. Event Master 150 detects the move into the second insurance plan field and again invokes Question Master 152. Question Master 152 responds by accessing the questionnaire file from workstation memory 146 or storage medium 132, and again displaying the initial question in window 202. Instructions are again displayed in second window 204, and in third window 206 the valid responses for the initial question are again displayed. In this example, the registrar selects the response “Anthem”, as shown in FIG. 10. Question Master 152 follows the decision path for the “Anthem” response to reach a second question.

FIG. 11 shows an exemplary second question, “What is the insurance plan prefix”, displayed in first window 202. Question Master 152 also displays an informational message for this question in second window 204. This informational message is retrieved by Question Master 152 from messages database 134. A plurality of valid responses for the second question are displayed in window 206. The displayed responses differ from the previously displayed responses, since a different question path was followed from the initial question. In addition to the question and informational message, Question Master 152 displays a pictorial image 212 related to the question. Pictorial image 212 assists the registrar in selecting from amongst the response choices. In the example shown, a picture of an insurance card is displayed. The image of an insurance card allows the registrar to verify that the insurance information provided by the health information system matches the patient's card, and also to pinpoint the location of an answer on the patient's card. After the registrar selects a response choice, Question Master 152 analyzes the response and determines the best course of action. In the example shown, Question Master returns an identifier for the patient's health insurance plan. This identifier is passed to Event Master 150 for insertion into the second insurance plan identification field in the health information system, as shown in FIG. 12.

After the registrar completes entry of a patient's insurance plan information, the registrar will tab on to the next field in the health information system. When the registrar moves away from the insurance plan identification fields 200, Event Master 150 evaluates the insurance plan identification fields for data. When Event Master 150 detects data entered into more than one insurance plan identification field, Event Master triggers COB Master module 170. Event Master 150 passes the identifiers from fields 200 to COB Master module 170. COB Master 170 processes the identifiers, and retrieves and displays any relevant questions needed to properly sequence the insurance plan identifiers. For example, as shown in FIG. 13, if the patient had Medicare insurance COB Master 170 would retrieve and display the question “Does the patient work for a company with 100 employees and is covered by their GHP?” Numerous other questions could also be asked by COB Master component 170 depending upon the types of insurance coverage carried by the patient. After the registrar obtains a response from the patient, and selects a reply as shown in window 216, COB Master 170 assigns the appropriate weights or values to each of the insurance plan identifiers passed from Event Master 150. Using the assigned values, COB Master 170 reorders the identifiers into a correct payment sequence. Following the sequencing process, COB Master 170 passes the identifiers back to Event Master 150, which reinserts the sequenced identifiers into fields 200 of the health information system, as shown in FIG. 14. As indicated by the order of identifiers in fields 200, the insurance plan identified as “ANTBPRE” should receive a claim for payment prior to the insurance plan identified as “UNHCMCR”. Accordingly, the sequence of the identifiers has been changed from the initial sequence shown in FIG. 12 to reflect the proper payment sequence.

If in the above-described exemplary registration session, the health information system had retrieved a prior record for the patient, the insurance plan identification fields 200, shown in FIG. 5, may have initially contained one or more insurance plan identifiers from a previous registration. In this instance, Event Master 150 would have called Keyword Master component 180, and passed the identifiers from fields 200 to the Keyword Master component. Keyword Master 180 would have returned the updated identifiers to Event Master 150 for reinsertion into insurance plan identification fields 200. The updated identifiers would then have been displayed to the registrar to enable the registrar to confirm with the patient that the displayed insurance information was correct.

IGR system 130 also includes an administrative component for building and maintaining the questionnaire files and databases within the system. The administrative component is a Windows® application that can be used to access and edit data files. Through standard Windows® screens, menus and button bars, a system administrator can easily modify the files within IGR system 130 without using computer programming code. Changes may be made at an individual healthcare facility to virtually any aspect of the IGR files including questions, responses, actions, COB rules, COB categories and weights, and insurance plan identifiers. The administrative component enables the IGR system to be quickly updated to reflect changes to insurance plans or other aspects of the patient registration process.

To make changes to a questionnaire file, a system administrator utilizes the Windows® menu bar to display the questionnaire file in decision tree format. FIG. 15 illustrates the question tree file for the exemplary initial question “What is the name of the insurance company”. The question is displayed at the top of a modification window 220. Below the question are listed the response choices that are displayed for the question, in the order in which they are presented in the questionnaire. To make changes to any of the responses or nodes listed in modification window 220, the administrator can right click on the node to display a context sensitive menu. The menu will contain only the functions that can be performed on that specific node. Alternatively, the administrator can highlight a node and then select from a menu towards the top of window 220. The available menu options will be context sensitive for the particular node.

In the example shown in FIG. 15, the administrator plans to make changes to an insurance plan that is not listed as a response in the initial question tree file. Therefore, the administrator selects the node “NOT IN THIS LIST”, as shown in FIG. 16, which enables the administrator to branch to a different question tree file to make the changes. In the IGR system, multiple question tree files can be linked together to form one logical question tree. An administrator may move between the question tree files to make changes by selecting particular nodes and dropping and dragging items between the nodes within the Windows® browser. As shown in FIG. 17, the “NOT IN THIS LIST” node branches to a single action item which is to load a different question tree file, as indicated by reference numeral 222. FIG. 18 illustrates how menu bar 224 can be used to load a file within the administrative mode by selecting the “Open” option. Additionally, FIGS. 19a and 19b show how menu bar 224 can be used to find a particular node within a question tree file for editing, by selecting the “Find” option and manually entering the particular character string to be located within the question tree file.

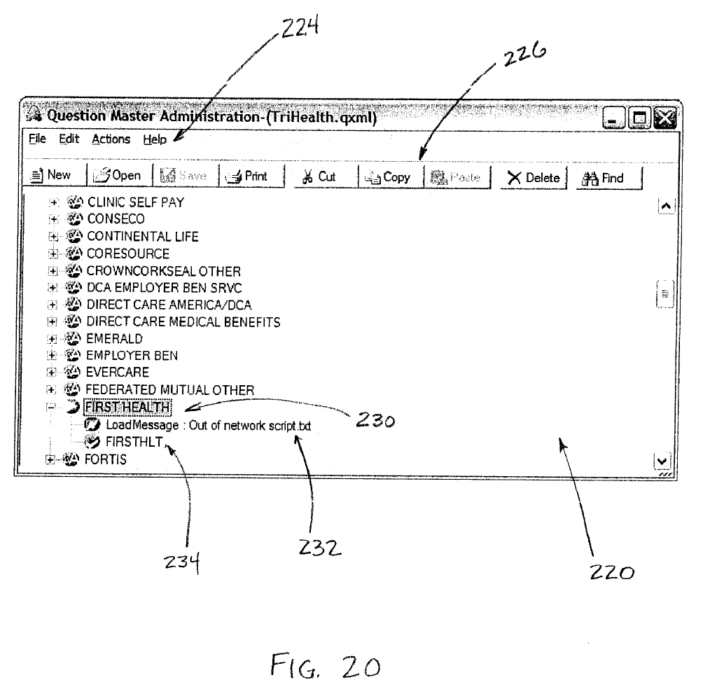

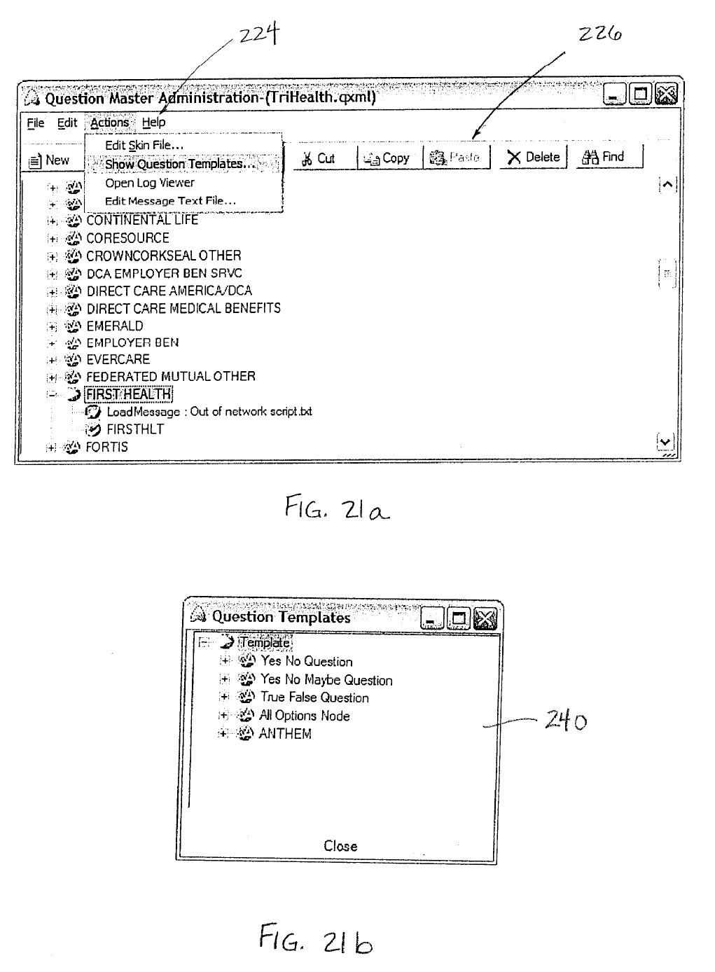

Once a particular node is found, the menu options may be used to expand the node to display all items under the node. In the example shown in FIG. 20, the selected node contains two items, an action to load a message to display to the registrar, indicated by reference numeral 232, and an action to return a specific health insurance plan identifier “FIRSTHLT”, as indicated by reference numeral 234. Changes to either of these actions could be entered manually by typing into modification window 220. The administrator can change the actions under the node by changing the message to be displayed to the user, or changing the “FIRSTHLT” identifier to a different identifying character string. The administrator may also add or remove particular actions from the node. Templates may be accessed through button bar 226 and menu 224 to modify the node or indicated actions under the node. FIGS. 21a and 21b show selection of an exemplary question template 240 from menu 224. The administrator may drag and drop question types from question template 240 to add a question to a node in a question tree. Other templates may also be selected to drag and drop answers, results and actions in order to modify a node in a question tree.

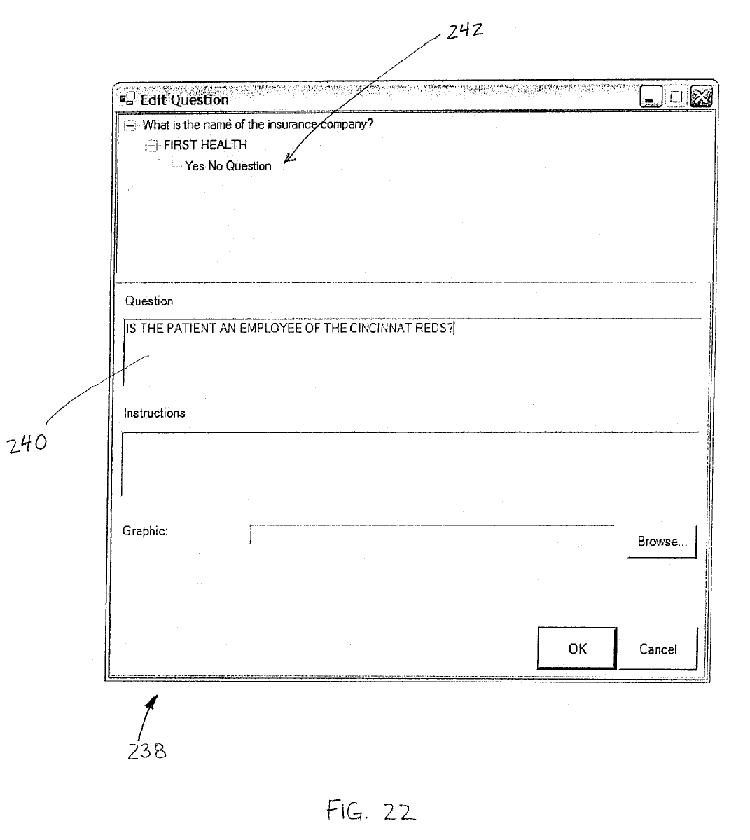

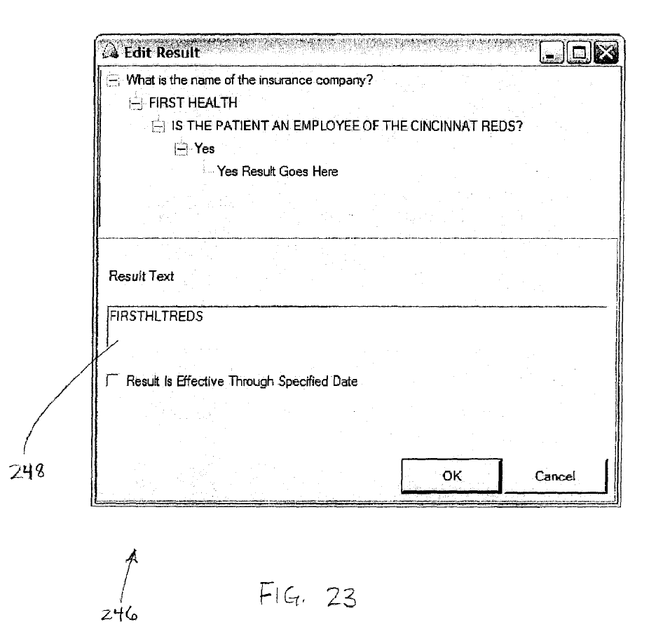

Additionally, menus available in the administrative component contain options to edit questions, answers and actions after the questions, answers and actions have been added to a question tree. FIG. 22 shows an exemplary edit screen 238 in which a question node in the question tree file is selected to be edited. In this example, a new question is entered into question window 240 to replace “Yes No Question” node 242, shown in the question tree. Following this editing step, the new question “IS THE PATIENT AN EMPLOYEE OF THE CINCINNATI REDS?” will be displayed when the FIRST HEALTH response is selected from the questionnaire. Edit Question screen 238 can be displayed by selecting Edit from menu bar 224, or by right clicking on the question node and selecting Edit from the pop-up context menu. Similarly, FIG. 23 shows an exemplary Edit Result screen 246 in which a Result window 248 is provided for editing a particular result or action to be taken in response to a question. In the screen shown, the identifier FIRSTHLTREDS is entered as an action to bc performed following a “YES” response to the question. Following this editing step, the identifier “FIRSTHLTREDS” will be automatically returned by Event Master when a user responds “YES” to the question, “IS THE PATIENT AN EMPLOYEE OF THE CINCINNATI REDS?” The edit result screen can be reached by selecting the Edit option from menu bar 224 or from a context-specific menu. The administrative mode exemplary screens described herein are only representative of the types of windows that can be utilized to modify aspects of the IGR system. Other Windows®t-based windows and menus may be accessed through the administrative component in order to modify other aspects of the IGR system.

After an administrator has entered changes to a question tree file, the changes may be tested before being accessed by the application programs on the user workstations. The administrator may verify the changes to the question files, and when satisfied that the changes are correct, make a selection from the menu bar to publish the changes to production. With the selection of a publish menu option, the administrator's changes are stored in question file storage medium 132 on server 106. The next time a registrar accesses the edited question file, the updated question file will be downloaded from database 130 to the registrar's workstation for display on the workstation graphical user interface.

While the present invention has been illustrated by description of an exemplary health insurance plan identification system, it is not the intention of the applicant to restrict or limit the spirit and scope of the appended claims to such detail. Numerous other variations, changes and substitutions to the IGR system will occur to those skilled in the art without departing from the scope of the invention. For example, the Event Master component could be configured to detect other designated fields within a health information system and trigger a guided selection process with respect to the other designated fields. Accordingly, the present invention can be utilized in other registration scenarios in which a registrar must select a particular identifier for a patient from a list of available identifiers, without departing from the scope and spirit of the appended claims.

What is claimed is:

1. A method for guiding a registrar during a patient registration in a health information system, the method comprising the steps of:
detecting a designated field within the health information system;
accessing a questionnaire upon detection of the designated field, the questionnaire including a first question and one or more responses for the first question;
displaying the questionnaire on a graphical user interface;
receiving a response to the questionnaire through an input device;
analyzing the received response in a computer process to determine whether the received response indicates an action to be performed or one or more additional questions in the questionnaire;
when the received response indicates at least one additional question in the questionnaire, continuing to display the questionnaire, receive responses and perform any indicated actions until an end processing action is performed.

2. The method of claim 1, wherein the end processing action comprises inserting an identifier into the designated field within the health information system.

3. The method of claim 1, wherein the questionnaire can be displayed in a graphical format, and a system administrator can graphically modify the questionnaire at an individual health care facility without the use of computer programming code.

4. The method of claim 2, wherein the steps may be performed multiple times during a patient registration.

5. The method of claim 4, further comprising the steps of:
detecting the insertion of multiple identifiers for a patient;
analyzing the multiple identifiers in a computer process; and
sequencing the multiple identifiers according to a predetermined hierarchy.

6. The method of claim 5, further comprising the step of reinserting the sequenced multiple identifiers into multiple designated fields in the health information system.

7. The method of claim 1, wherein an indicated action comprises retrieving an informational message from a digital storage medium and displaying the message on the graphical user interface.

8. The method of claim 1, wherein an indicated action comprises retrieving a pictorial image from a digital storage medium, and displaying the pictorial image on the graphical user interface.

9. A method of facilitating selection of a health insurance plan during a patient registration session in a health information system, the method comprising the steps of:
detecting an insurance plan identification field within the health information system;
accessing a health insurance questionnaire upon detection of the insurance plan identification field, the health insurance questionnaire including at least one question having one or more responses;
displaying the health insurance questionnaire on a graphical user interface;
receiving a response to the questionnaire through an input device;
analyzing the received response in a computer process to determine whether the received response branches to one or more additional questions in the questionnaire or an action to be performed;
when the received response branches to at least one additional question in the questionnaire, iteratively displaying additional questions, and analyzing received responses to the additional questions, until a received response branches to an end processing action; and
performing the end processing action.

10. The method of claim 9, wherein the end processing action comprises inserting a health insurance plan identifier into the insurance plan identification field of the health information system.

11. The method of claim 10, wherein the steps may be repeated multiple times during a patient registration to perform multiple actions.

12. The method of claim 11, wherein the method further comprises the steps of:
detecting the insertion of multiple health insurance plan identifiers into insurance plan identification fields within the health information system;
sequencing the multiple health insurance plan identifiers in a computer process according to a claim payment hierarchy; and
reinserting the sequenced multiple health insurance plan identifiers into the insurance plan identification fields of the health information system.

13. The method of claim 9, wherein the health insurance questionnaire can be displayed in a graphical format, and a system administrator can graphically modify the health insurance questionnaire at an individual health care facility without the use of computer programming code.

14. A system for facilitating the performance of an action in conjunction with a patient registration at a health care facility, the system comprising:
a monitor for detecting a designated field in a health information system;
a first computer process for retrieving a questionnaire in response to detection of the designated field, the questionnaire including one or more questions, responses and actions related together in a decision structure;
a graphical user interface for displaying the questionnaire;
an input device for receiving user responses to the one or more questions;
a second computer process for analyzing user responses to the questionnaire, the second computer process including processing means for reiteratively displaying questions from the questionnaire and receiving user responses in a decision path until the path terminates at an end processing action; and
computer processing means for performing the end processing action in conjunction with the patient registration.

15. The system of claim 14, wherein the system can perform multiple actions in conjunction with a single patient registration.

16. The system of claim 15, wherein the end processing action comprises insertion of an identifier into the detected designated field of the health information system.

17. The system of claim 16, wherein the identifier is a health insurance plan identifier, and the designated field is a health insurance plan identification field.

18. The system of claim 17, further comprising:
monitor processing means for detecting the insertion of multiple insurance plan identifiers into multiple insurance plan identification fields in the health information system; and
a computer process for sequencing the multiple insurance plan identifiers according to a claim payment hierarchy and returning the sequenced multiple insurance plan identifiers to the health information system.

19. The system of claim 14, further comprising an administrative module for graphically modifying the questionnaire without using computer programming code.

20. The system of claim 19, wherein the administrative module is a Windows® application and the questionnaire is graphically modified using Windows®-based screens and menus.
